(19) United States
(12) Patent Application Publication
(10) Pub. No.: US 2005/0219614 A1
(43) Pub. Date: Oct. 6, 2005

(54) Scalable hierarchical-states based job management engine with resource balancing and services monitoring

(76) Inventors: Man M. Garg, Cerritos, CA (US); Hongfeng Wei, Anaheim, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 11/098,053

(22) Filed: Apr. 4, 2005

Related U.S. Application Data
(60) Provisional application No. 60/559,183, filed on Apr. 2, 2004.

(51) Int. Cl. G06F 15/00

(52) U.S. Cl. 358/1.15

(57) ABSTRACT

A system and method for system and method for monitoring processes in a document processing peripheral. The system comprises a document processing peripheral device suitably equipped with a job manager. The job manager includes at least one state, or service object that represents a service or process to be performed on a print job. The state objects trigger services through messaging based on the workflow programmed into the objects. A core engine drives the objects and pumps the jobs to the objects. A service or processor receive the jobs via messaging and process the jobs in accordance with the service it is programmed to perform. The state objects then track the resources used by the jobs.

### CROSS-REFERENCE TO RELATED APPLICATIONS

This Application claims the benefit of U.S. Provisional Application Ser. No. 60/559,183 filed Apr. 2, 2004, entitled, “SCALABLE HIERARCHICAL-STATES BASED JOB MANAGEMENT ENGINE WITH RESOURCE BALANCING AND SERVICES MONITORING”, which is incorporated by reference herein.

### BACKGROUND

This invention is directed to a system and method for document processing job management. More particularly, this invention is directed to a system and method for the job management of document processing wherein a scalable hierarchical job management engine monitors services, balances resources and increases processing workflow.

Conventional printing systems have a straightforward workflow method in place, such as receiving a document, processing the document, and printing the document. In contrast, newer printing systems enable a larger variety of features to be employed in the document processing system. For example, newer systems include such features as scheduled printing, private printing, store-recompose-printing, email in/out, facsimile, etc. These additional features add further complexity to the workflow that a peripheral device is expected to handle. In addition to the added complexity of the workflow, new services and processing is required within the printing server, requiring the allocation of additional hardware resources in the performance of the service or process.

The typical printing system uses a job management component. This component is tasked with controlling the passage of a document through the printing process. Printing systems in general use also incorporate additional monitoring components, tasked with monitoring the performance of the services by the system, as well as alerting an administrator or user when a service fails to respond.

Thus there is a need for a system and method for workflow management, resource balancing and services monitoring.

### SUMMARY OF INVENTION

In accordance with the present invention, there is taught a system and method for monitoring processes in a document processing peripheral.

Further, in accordance with the present invention, there is taught a job management system comprising a collection of hierarchical state objects assembled at design time and driven through a central engine. The system comprises a document processing peripheral device suitably equipped with a job manager. The job manager includes at least one state, or service object that represents a service or process to be performed on a print job. The state objects trigger services through messaging based on the workflow programmed into the objects. The central engine drives the objects and pumps the jobs to the objects. A service or processor receive the jobs via messaging and process the jobs in accordance with the service it is programmed to perform. The state objects then track the resources used by the jobs.

Still further in accordance with the present invention, there is provided a system for system for document processing job management. The system includes receiving means adapted to receive a job request that is associated with an electronic document. The job request includes document processing operations associated with the electronic document. The system also includes status message receiving means adapted to receive a status message relative to one of the document processing operations. The system further includes calculation means adapted for calculating routing data according to the document processing operations and signal generation means adapted for generating a routing signal according to the received status message. The routing signal specifies a routing for completion of the document processing operations.

Further, in accordance with the present invention, there is provided a method for document processing job management. The method begins by receiving a job request associated with an electronic document. The job request includes document processing operations associated with the electronic document. Next, a status message is received relative to at least one of the document processing operations. A calculation is then made to determine routing data according to the document processing operations and a routing signal is generated according to the received status message. The routing signal specifies a routing for completion of the document processing operations.

Still further in accordance with the present invention, there is taught a method for managing the workflow of a printing system. The method comprises the step of building state objects representing services to be performed by a document processing peripheral device. The state objects are then assembled in a hierarchical structure. The method further comprises the step of receiving a message containing a trigger. The trigger represents a service which is to be performed. The method includes the step of monitoring the resources used by the service and balancing the resources through a job routing algorithm.

Still other objects and aspects of the present invention will become readily apparent to those skilled in this art from the following description wherein there is shown and described a preferred embodiment of this invention, simply by way of illustration of one of the best modes suited for to carry out the invention. As will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a block diagram of a job manager component according to the present invention; and

FIG. 3 is a flow chart illustrating the method according to the present invention.

### DETAILED DESCRIPTION OF THE EMBODIMENTS

This invention is directed to a system and method for managing the workflow of a document processing peripheral. More particularly, this invention is directed to a system and method for managing the workflow of a document processing peripheral, monitoring the services of a document processing peripheral, and balancing the resources of the document processing peripheral, using hierarchical state objects.

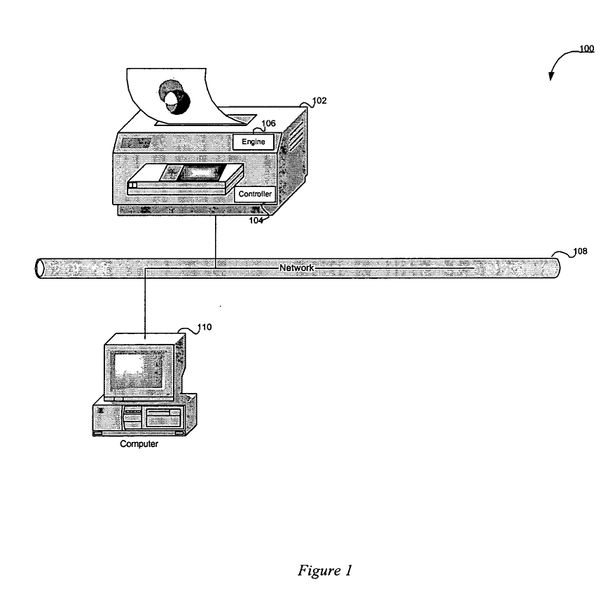

FIG. 1 illustrates a block diagram preferred embodiment of the system according to the present invention generally designated as 100. The system comprises at least one document processing peripheral, as illustrated by multi-function peripheral device 102, for generating or processing image data. It is to be appreciated that document processing peripheral is any suitable document processing device known in the art, such as a copier, printer, scanner, facsimile and the like, or any combination thereof. Suitable commercially available document processing peripherals include, but are not limited to, the Toshiba e-Studio Series Controller. The document processing peripheral of the system 100 further comprises a controller 104 which controls the functions of the document processing peripheral as will be appreciated by one of ordinary skill in the art. The controller 104 of the document processing peripheral 102 comprises a central engine 106. The central engine 106 is communicatively coupled to the document processing peripheral 102.

The document processing peripheral device 102 is communicatively coupled to a computer network 108. The computer network 106 further comprises at least one electronic device capable of transmitting job data to the document processing peripheral device 102. As shown in FIG. 1, a personal computer 110 is suitably adapted to transmit job data over the computer network 108 to the document processing peripheral device 102 via any suitably transportation protocol. It will be appreciated by those skilled in the art that the job data suitably comprises document generation data enabling the document processing peripheral device 102 to output the document for which the job data pertains.

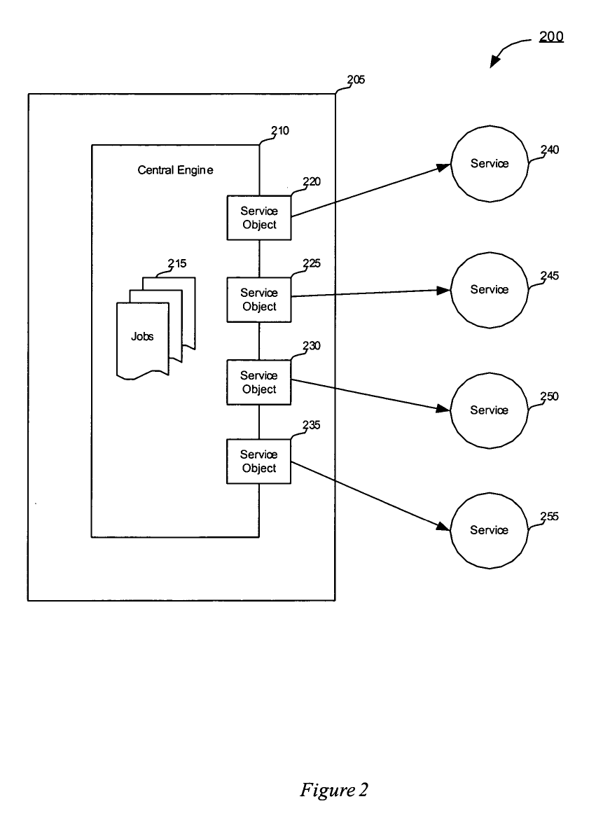

FIG. 2 illustrates a block diagram of the job manager component 200 of the present invention. The job manager component 200 comprises a document processing peripheral device 205, having a core engine 210, and at least one service 240. As shown, the job manager component 200 includes four services, 240, 245, 250, and 255. It will be understood by those skilled in the art that the use of four services is for exemplary purposes and the subject invention is not limited to only four services. Each of the services 240, 245, 250, and 255 represent a particular document generating or control service or process and the resources used by their respective service or process.

The core, or central, engine 215 of document processing peripheral device 205 comprises a number of service (e.g., state) objects (e.g. 220, 225, 230 and 235) corresponding to the number of services (e.g. 240, 245, 250 and 255). It will be understood by the skilled artisan that the ratio of state objects to services is exemplified in FIG. 2 as 1:1, however application of the subject invention is not limited to such a ratio. The central engine 210 further comprises one or more jobs 215. The skilled artisan will appreciate that the jobs 215 represent document generation data corresponding to a document or print job. The state objects 220, 225, 230, and 235 represent a corresponding service 240, 245, 250 and 255 in the job manager component 200.

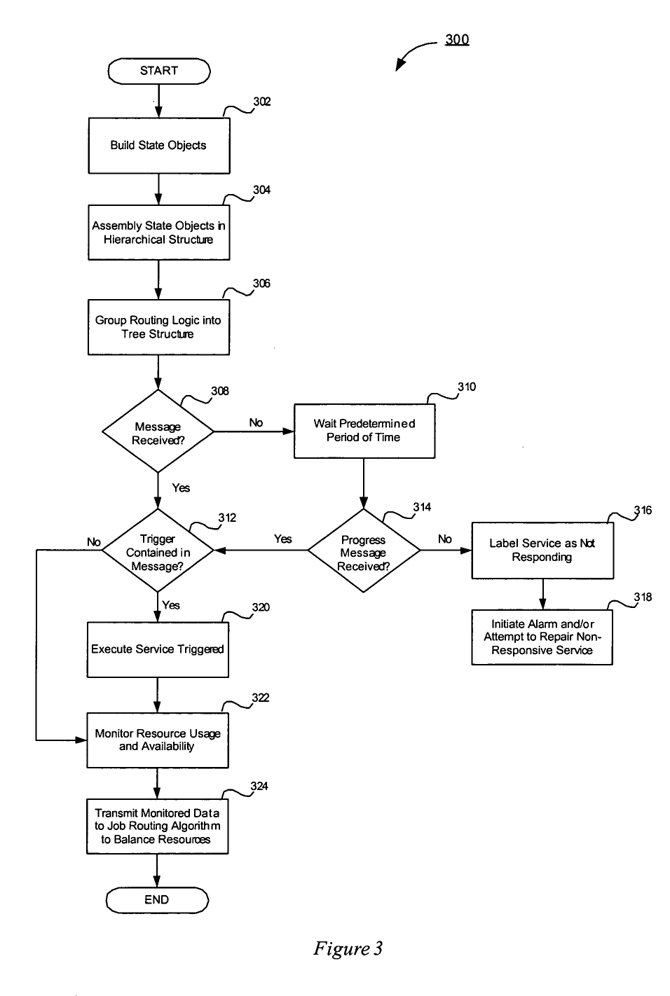

The central engine 210 drives the state objects 220, 225, 230 and 235 and pumps the jobs 215 to the objects 220, 225, 230 and 235. The services (e.g. processors) 240, 245, 250 and 255 receive the jobs 215 when messages are received by them and subsequently process the jobs 215. The state objects 220, 225, 230 and 235 then track the resources used by the jobs 215. The foregoing job manager component 200 and the embodied system 100 are best understood when taken in addition to the method described below in FIG. 3.

Referring now to FIG. 3, there is shown a flow chart illustrating a preferred embodiment of the method according to the present invention generally designated as 300. The method begins at step 302 by building state objects. As will be appreciated by those skilled in the art an object, as described in step 302, is a representation of each job service or process that performs a task on the job data. Thus, the objects represent a job service or process, performed within the job manager. The state objects perform interaction with job processors and services through messaging and drive the job's lifecycle through the processors and services.

At step 304, the state objects are assembled in an hierarchical structure at design time to construct a job routing behavior. The skilled artisan will also appreciate that the hierarchical structure into which the state objects are organized enables, at step 306, the grouping of the routing logic, or behavior, into a tree structure, so that processing and servicing of the job is optimized. It will be appreciated by those skilled in the art that during operation, the central engine drives this behavior to route the job through the job management system. It will also be appreciated by those skilled in the art that states driving the job flow are created and added in the tree structure to expand functionality for new types of jobs or new types of printing features.

At step 308, it is determined that a message has not yet been received by the central, e.g., core, engine, in which the job management system resides. Upon this determination, the central engine waits for a predetermined period of time at step 310. This period is suitably configured by a system administrator or user of the job management system. After the predetermined period of time has elapsed, the engine determines at step 314 that a progress message has not been received. It will be appreciated by those skilled in the art that the progress message is any format suitably adapted for informing the engine on the progress of the service or process the object represents. The artisan will further appreciate that each service or process sends the progress message as the job passes through that particular service or process.

Upon the determination, at step 314, that a progress has not been received after the conclusion of the predetermined period of time of step 310, the service or process is labeled at step 316 as not responding. Subsequently, at step 318, the engine initiates either an alarm and/or attempts to repair the service or process to progress the job through to the next service or process. It will be appreciated by the skilled artisan that the engine will attempt to repair the service by messaging other objects, such as a service control manager, to reconfirm service health or restart the faulty, e.g., non-responsive, service.

When a message has been received at step 308, it is then determined that the received message contains a trigger at step 312. It will be appreciated by those skilled in the art that the trigger is any suitable notification that informs the engine that a job has been created, destroyed or progressed through the job management system. In an alternate embodiment, a timer trigger is added to the message to facilitate the processing of jobs by the engine on a time dependent basis. For example, the engine is adapted to process scheduled jobs or clean-up pending jobs when the timer trigger is enabled, indicating that the system, e.g., engine, has no other pending activities.

Upon the receipt of a trigger in the message at step 312, the central engine executes the action indicated by the trigger at step 320. The system then monitors the resource usage and availability of resources for the object, e.g., job service or process, at step 322. The monitored usage and availability data is subsequently transmitted to a job routing algorithm to balance system resources at step 324. It will be appreciated by those skilled in the art that the services are allotted resources to be used by the service through the job routing algorithm.

Returning to step 314, when a progress message is received, the central engine then determines if a trigger is contained within the message at step 312. In the event that a trigger is included in the message, the system progresses to execute the triggered service at step 320 and monitor and report the data as set forth in steps 322 and 324, respectively. When the system determines at step 312 that no trigger is included within the message, the system proceeds to monitor resources at step 322 and transmit the monitored usage data to the job routing algorithm at step 324.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A system for document processing job management comprising:
means adapted for receiving a job request associated with an associated electronic document, which job request includes a plurality of document processing operations associated with the associated electronic document;
means adapted for receiving a status message relative to at least one of the plurality of document processing operations;
means adapted for calculating routing data in accordance with the plurality of document processing operations; and
means adapted for generating a routing signal in accordance with a received status message, which routing signal specifies a routing for completion of the plurality of document processing operations.

2. The system for document processing job management of claim 1 wherein the status message includes at least one of a job identifier representative of a document processing operation to be performed and an apparatus status representative of a state of at least one associated document processing apparatus adapted for undertaking the document processing operation.

3. The system for document processing job management of claim 2 wherein the routing signal includes data representative of at least one of an ordering of the plurality of document processing operations and data representative of a selected apparatus for completion thereof.

4. The system for document processing job management of claim 3 wherein the means for calculating routing data includes an optimization means adapted for optimizing a completion of the plurality of document processing operations in accordance with available document processing apparatuses and ordering of document processing operations.

5. The system for document processing job management of claim 4 wherein a state of at least one of the available document processing apparatuses is non-functional, further comprising initiation means adapted for initiating an alarm representative of the non-functional state the at least one available document processing apparatus.

6. The system for document processing job management of claim 4 wherein the ordering of document processing operations is hierarchical.

7. The system for document processing job management of claim 4 wherein the document processing operation is one of the group consisting of scheduled printing, private printing, store-recompose-printing, email in/out, copying, and facsimile printing.

8. A method for document processing job management comprising the steps of:
receiving a job request associated with an associated electronic document, which job request includes a plurality of document processing operations associated with the associated electronic document;
receiving a status message relative to at least one of the plurality of document processing operations;
calculating routing data in accordance with the plurality of document processing operations; and
generating a routing signal in accordance with a received status message, which routing signal specifies a routing for completion of the plurality of document processing operations.

9. The method for document processing job management of claim 8 wherein the status message includes at least one of a job identifier representative of a document processing operation to be performed and an apparatus status representative of a state of at least one associated document processing apparatus adapted for undertaking the document processing operation.

10. The method for document processing job management of claim 9 wherein the routing signal includes data representative of at least one of an ordering of the plurality of document processing operations and data representative of a selected apparatus for completion thereof.

11. The method for document processing job management of claim 10 wherein the calculating routing data step further includes the step of optimizing a completion of the plurality of document processing operations in accordance with available document processing apparatuses and ordering of document processing operations.

12. The method for document processing job management of claim 11 wherein a state of at least one of the available document processing apparatuses is non-functional, further comprising the step of initiating an alarm representative of the non-functional state of the at least one available document processing apparatus.

13. The method for document processing job management of claim 11 wherein the ordering of document processing operations is hierarchical.

14. The method for document processing job management of claim 11 wherein the document processing operation is one of the group consisting of scheduled printing, private printing, store-recompose-printing, email in/out, copying, and facsimile printing.

15. A computer-readable medium of instructions with computer-readable instructions stored thereon for document processing job management, comprising:
instructions for receiving a job request associated with an associated electronic document, which job request includes a plurality of document processing operations associated with the associated electronic document;
instructions for receiving a status message relative to at least one of the plurality of document processing operations;
instructions for calculating routing data in accordance with the plurality of document processing operations; and
instructions for generating a routing signal in accordance with a received status message, which routing signal specifies a routing for completion of the plurality of document processing operations.

16. The computer-readable medium of instructions with computer-readable instructions stored thereon for document processing job management of claim 15 wherein the status message includes at least one of a job identifier representative of a document processing operation to be performed and an apparatus status representative of a state of at least one associated document processing apparatus adapted for undertaking the document processing operation.

17. The computer-readable medium of instructions with computer-readable instructions stored thereon for document processing job management of claim 16 wherein the routing signal includes data representative of at least one of an ordering of the plurality of document processing operations and data representative of a selected apparatus for completion thereof.

18. The computer-readable medium of instructions with computer-readable instructions stored thereon for document processing job management of claim 17 wherein the instructions for calculating routing data further include instructions for optimizing a completion of the plurality of document processing operations in accordance with available document processing apparatuses and ordering of document processing operations.
